(19) United States
(12) Patent Application Publication
(10) Pub. No.: US 2007/0240741 A1
(43) Pub. Date: Oct. 18, 2007

(54) Apparatuses and Methods for Removing Particulate Materials

(75) Inventor: Daniel T. Lease, Spring Grove, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: GENERAL KINEMATICS CORPORATION, Crystal Lake, IL (US)

(21) Appl. No.: 11/696,894

(22) Filed: Apr. 5, 2007

Related U.S. Application Data
(60) Provisional application No. 60/789,830, filed on Apr. 6, 2006.

(51) Int. Cl. B08B 7/00; B08B 3/12

(52) U.S. Cl. 134/33; 134/1

(57) ABSTRACT

A vibratory apparatus for removing particulate materials from an object includes a container having a curved inner surface disposed about a generally horizontally extending longitudinal axis, the container being resiliently supported above a base. A plate is disposed in the container with a first edge spaced from the curved surface of the container and a second edge proximate to the curved surface of the container, the plate having openings therethrough. A vibration generator produces a vibratory force to cause the object and media within the container to be moved in a generally rising and falling path of rolling movement along the curved inner surface, the motion of the object being impeded by the plate while the motion of the media is not impeded by the plate, the media instead moving through the openings in the plate.

This application claims the benefit of U.S. application Ser. No. 60/789,830, filed Apr. 6, 2006, which is hereby incorporated by reference in its entirety in the present application.

### BACKGROUND

This patent is directed to apparatuses and methods for removing particulate materials from an object, and, in particular, to apparatuses and methods for removing particulate materials from an object to which they have adhered, been disposed in, etc.

A traditional method of casting metals is in sand molds. A pattern whose contour is in the shape of the desired casting is disposed in the sand to make an imprint, and then removed. A gating system is formed in the sand to allow the molten metal to flow into the imprint. Molten metal is poured into the mold, and the metal is allowed to cool, or solidify. After solidification, the casting is shaken out of the mold.

However, even after the casting has been shaken out of the mold, sand and other particulate matter will adhere to the casting. Additionally, sand and other particulate matter may become compacted within internal passages and cavities of the casting. Given that this sand and other particulate material may negatively affect the further processing of the casting, it is desired to remove, or clean, as much of the sand and particulate matter from the casting.

One known method of cleaning the casting is to dispose the casting in a cylindrically-shaped drum with a cleaning media. The drum is caused to revolve about its axis, causing the media and the casting to move within the drum. The media typically has a rectangular-, square- or star-shape, and as the media and the casting move, the edges of the media cause the sand and other particulate matter to be removed from the surface of the casting.

Unfortunately, this method has certain disadvantages. For one thing, the sharp-edged media not only removes sand from the casting, it may also cause damage to the casting. Moreover, it is believed that the media and the casting have a tendency to move in a pattern that actually does not result in significant relative motion between the media and the casting, thus limiting the effectiveness of the media in removing sand and particulate matter from the casting.

Consequently, it is desired to have alternative apparatuses and methods for removing particulate materials from an object.

### SUMMARY

According to an aspect of the disclosure, a vibratory apparatus for removing particulate materials from an object is provided. The apparatus includes a container having a curved inner surface disposed about a generally horizontally extending longitudinal axis, the container having an input end and an axially-spaced output end opposite the input end, the container being mounted on a plurality of resilient members so as to be resiliently supported above a base. A plate is disposed in the container, the plate having a first edge spaced from the curved surface of the container and a second edge proximate to the curved surface of the container, and having openings therethrough. A vibration generator produces a vibratory force to cause an object and media within the container to be moved in a generally rising and falling path of rolling movement along the curved inner surface, the motion of the object being impeded by the plate while the motion of the media is not impeded by the plate, the media instead moving through the openings in the plate.

According to another aspect of the disclosure, a method of removing particular materials from an object includes disposing an object and media in a container having a curved inner surface disposed about a generally horizontally extending longitudinal axis, the container being resiliently supported above a base, and the container having a plate with a first edge spaced from the curved surface of the container and a second edge proximate to the curved surface of the container, the plate having openings therethrough. The method also includes applying a vibratory force to cause the object and media within the container to be moved in a generally rising and falling path of rolling movement along the curved inner surface, the motion of the object being impeded by the plate while the motion of the media is not impeded by the plate, the media instead moving through the openings in the plate.

### BRIEF DESCRIPTION OF THE DRAWINGS

FIG. 1 is a front view of an apparatus for removing particulate materials according to the present disclosure;

FIG. 2 is an end view of the apparatus of FIG. 1;

FIG. 3 is a rear view of the apparatus of FIG. 1;

FIG. 4 is an enlarged, end view showing the motion of cleaning media and objects to be cleaned within the apparatus of FIG. 1;

FIG. 5 is a front view of a perforated plate for use in the apparatus of FIG. 1;

FIG. 6 is a front view of another perforated plate for use in the apparatus of FIG. 1;

FIG. 7 is a front view of a medium for use in the apparatus of FIG. 1; and

FIG. 8 is a front view of another medium for use in the apparatus of FIG. 1.

### DETAILED DESCRIPTION OF VARIOUS EMBODIMENTS

Although the following text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

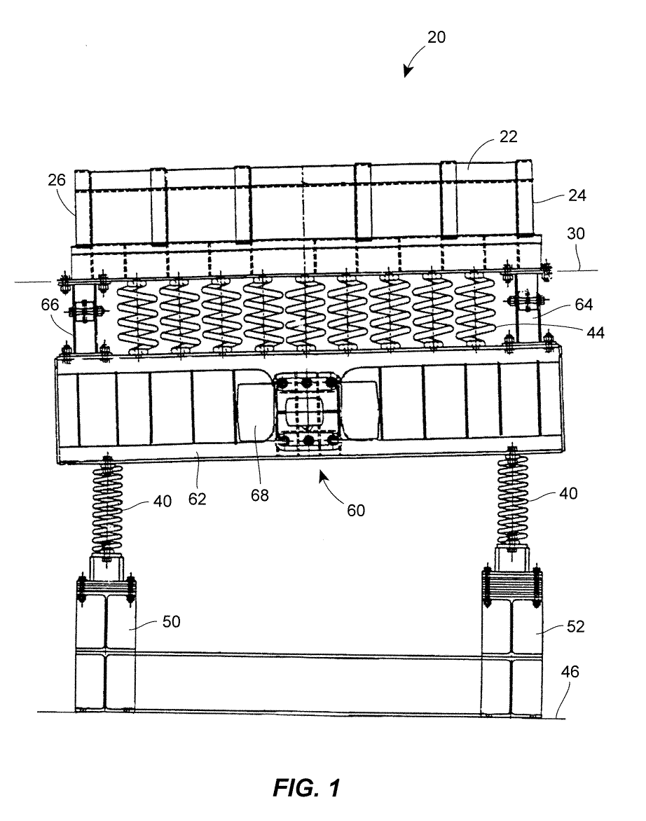

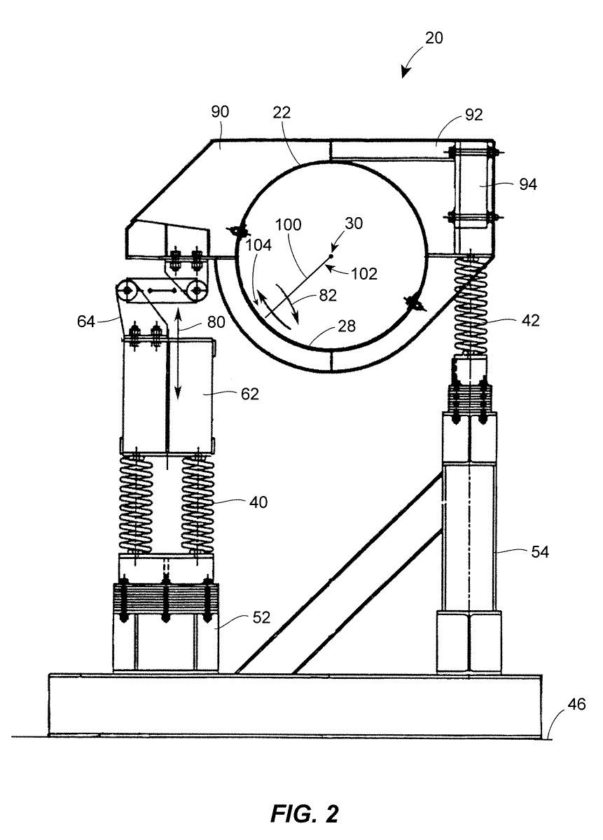

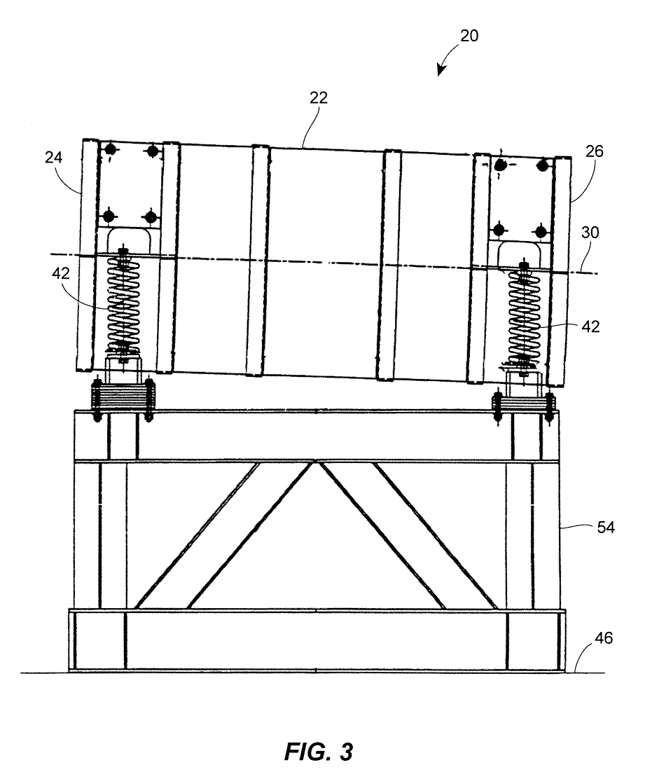

Referring first to FIG. 1, an apparatus 20 for removing particulate materials from an object, such as sand from a casting, includes a cylindrical drum or container 22. The container 22 has an input end 24, and an axially-spaced output end 26 opposite the input end 24. As seen in FIG. 2, the container 22 has a curved inner surface 28 disposed about a generally horizontally extending longitudinal axis 30 (appearing as a point in FIG. 2, and as a line in FIGS. 1 and 3).

The container 22 is mounted on a plurality of resilient members, or springs, 40, 42, 44 so as to be resiliently supported above a base 46. The springs 40 isolate the container 22 from the base 46 on one side, while the springs 42 isolate the container 22 from the base 46 on the other side. The springs 40, 42 may be set apart from the base 46 by, for example, steel columns 50, 52 (FIG. 1) and a steel support structure 54 (FIGS. 2 and 3), respectively.

The apparatus 20 also includes a vibratory generator 60. The vibratory generator 60 may comprise a beam 62 that spans the springs 40. The beam 62 is coupled to the container 22 by rocker leg assemblies 64, 66, disposed generally at or near the input end 24 and the output end 26, respectively. The beam 62 is also coupled to the container 22 by the springs 44, which springs 44 span the beam 62 between the rocker leg assembly 64 and the rocker leg assembly 66. In this manner, the container 22 has freedom of movement constrained only by the rocker leg assemblies 64, 66 and the springs 44 in response to a vibratory force produced by the vibratory generator 60. In addition, the vibratory generator 60 may include a pair of eccentric weight motors mounted on opposite sides of the beam 62, one of which is shown in FIG. 1 at 68.

The vibratory force produced by the vibratory generator 60 is generally represented by the double-ended arrow 80 in FIG. 2. It will be recognized that the vibratory force 80 is directed generally along a linear path which is (i) displaced from the generally horizontally extending longitudinal axis 30 and (ii) displaced from the center of gravity of the container 22. As will also be appreciated, the plurality of resilient members 40, 42, 44 mount the container 22 for unconstrained vibratory movement in response to the vibratory force 80 produced by the vibratory generator 60.

The vibratory force 80 causes objects to move within the container 22. Objects placed in the container 22 are moved in a generally rising and falling path of rolling movement along the curved inner surface 28 of the container 22, as generally represented by the double-ended arrow 82 in FIG. 2. The rolling movement occurs as the objects are being transported in the direction of the generally horizontally extending longitudinal axis 30 from the input end 24 toward the output end 26 of the container 22.

To assist the movement of the objects along the axis 30, the container 22 may be mounted such that the generally horizontally extending longitudinal axis 30 is actually inclined downwardly from the input end 24 to the output end 26. The downward inclination of the container 22 causes the objects to be transported, in part, by gravity from the input end 24 toward the output end 26.

It will be recognized from FIG. 2, for example, that the container 22 may include a pair of outwardly extending arms 90, 92. The arms 90, 92 may each include an integrally associated ballast weight, such as the weight 94 (see FIG. 2) that is on the side of the container 22 opposite the vibratory generator 60. The ballast weights assist in producing the vibratory force 80, and the vibratory force 80 may be modified by modifying, for example, the placement and size of the ballast weights.

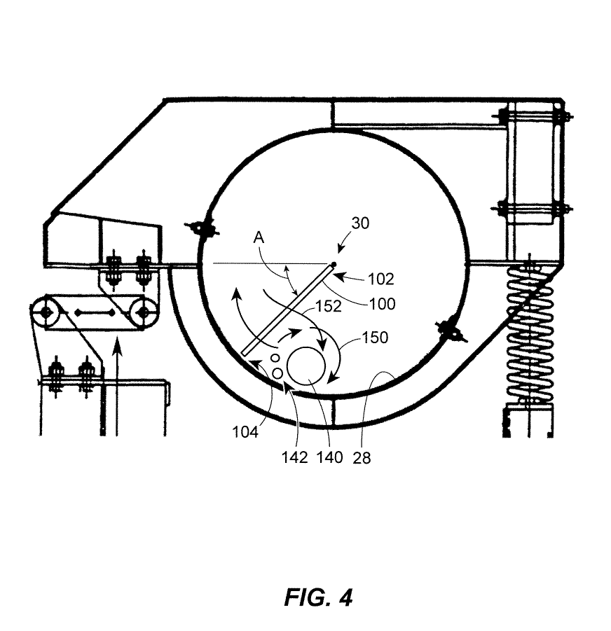

Turning now to FIGS. 2 and 4, it will be recognized that disposed within the container 22 is a plate 100. As shown, the plate 100 may have a first edge 102 that is disposed generally along the axis 30 of the container 22. The plate 100 also may have a second edge 104 that may be disposed so that the edge 104 abuts the curved surface 28 of the container 22. The plate 100 is disposed at a particular angle A (FIG. 4) relative to the horizontal.

As will become apparent, the position of the plate 100 may be varied relative to that shown in FIGS. 2 and 4. For example, it is not necessary that the edge 104 abut the curved surface 28 along its entire length, or abut the surface at all—the edge 104 may be disposed so that a gap exists between the edge 104 and the curved surface 28. Similarly, the angle A illustrated is merely one such possibility; the plate may be disposed at other angles relative to the horizontal while remaining within the scope of the present disclosure.

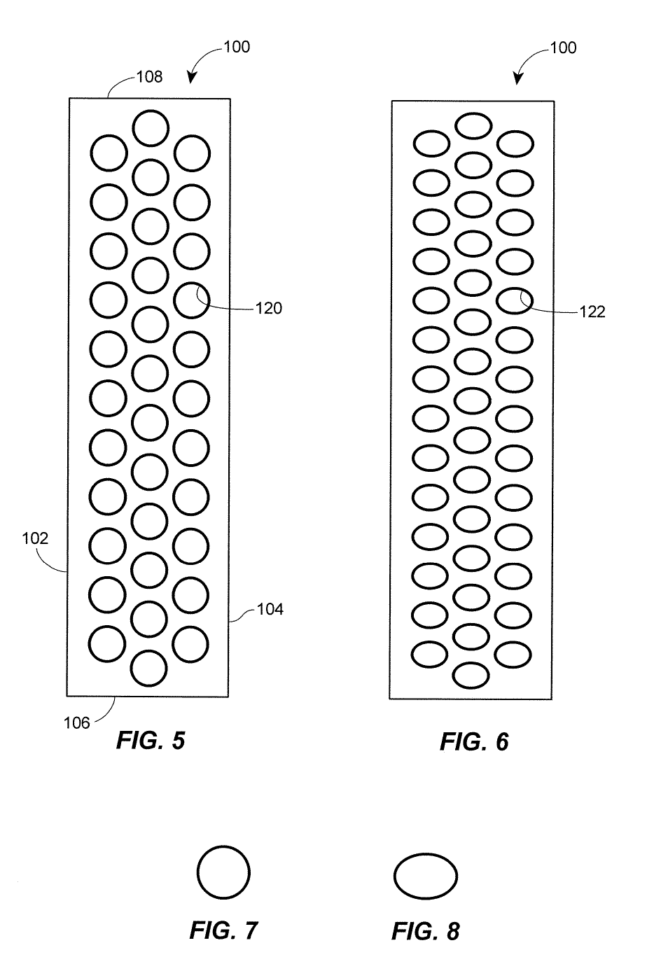

As seen in FIG. 5, the plate 100 may also have a first end 106 and a second end 108. With the plate disposed as shown in FIGS. 2 and 4, the first end 106 may be disposed at or near the input end 24, and the second end may be disposed at or near the output end 26. The first end 106 of the plate 100 may be disposed within the container 22, or may depend outwardly from the container 22. Similarly, the first end 106 of the plate 100 may be disposed within the container 22, or may depend outwardly from the container 22.

As also seen in FIG. 5, the plate 100 may have openings 120 therethrough. The plate 100 may thus be referred to as a perforated plate. As seen in FIG. 5, the openings 120 may have a uniform, circular shape, may be of a particular size relative to each other and the dimensions of the plate 100 and may be of a particular density per unit area of the plate 100.

However, it will be recognized that the openings 120 illustrated in FIG. 5 serve as a non-limiting example only. The shape of the openings may be other than circular, such as the oval openings 122 shown in FIG. 6. The openings 120 may be non-uniform, with the openings 120 closer to the edge 104 that is closest to the curved surface 28 larger or smaller in dimension (e.g., diameter) relative to the openings 120 closer to the edge 102 that is closest to the axis 30. The size of the openings 120 may also vary between the first and second ends 106, 108. The size of the openings 120 may be smaller or larger than that shown in FIG. 5, and may have a different density per unit area of the plate 100.

It is believed that the presence of the plate 100 in the container 22 may have a positive effect on the ability of a media disposed in the container 22 to remove particulate materials from objects disposed in the container 22. Moreover, it is believed that the presence of the plate 100 in the container 22 may permit smooth-shaped media, such as in the form of blasting shot, which is round or ovoid in shape (see FIGS. 7 and 8), to be used to remove the particulate materials from the object disposed in the container 22, although other media may be used as well.

To illustrate this concept, an object 140, such as a casting, is illustrated in FIG. 4 as disposed in the container 22 to the right side of the plate 100. The object 140 may have materials (e.g., sand, binder, oxides) adhering to or disposed on it. Also disposed in the container 22 may be a cleaning media 142, such as, for example, blasting shot.

With the vibratory generator 60 activated, a rolling motion will be imparted to the object 140 and the media 142. As will be recognized, the motion of the object 140 is impeded in the clockwise direction, as shown in FIG. 4, by the plate 100. However, the motion of the media 142 is not impeded by the plate 100, because of the presence of the openings 120 in the plate 100. The media 142 passes further up the curved surface 28 before returning through the openings 120 in the plate 100. It is believed that the relative movement patterns of the object 140 and the media 142 would be as represented in FIG. 4 by curved arrows 150, 152, respectively.

It is believed that these motion patterns may have several benefits. First, by constraining the motion of the object 140, through the placement of the plate 100, a faster angular motion may be imparted to the object 140 than if the plate 100 were not present. Further, the passage of the media 142 through the openings 120 in the plate 100 is believed to increase the relative motion of the media 142 relative to object 140. Further, this relative motion may be perceived as an increase in the force exerted by the media 142 against the surface of the object 140. Any or all of these effects are believed to result in an increased removal of the materials from the surface, interior passages, cavities, etc. of the object 140.

What is claimed is:

1. A vibratory apparatus for removing particulate materials from an object, comprising:
a container having a curved inner surface disposed about a generally horizontally extending longitudinal axis, the container having an input end and an axially-spaced output end opposite the input end, the container being mounted on a plurality of resilient members so as to be resiliently supported above a base;
a plate is disposed in the container, the plate having a first edge spaced from the curved surface of the container and a second edge proximate to the curved surface of the container, and having openings therethrough; and
a vibration generator for producing a vibratory force to cause an object and media within the container to be moved in a generally rising and falling path of rolling movement along the curved inner surface,
the motion of the object being impeded by the plate while the motion of the media is not impeded by the plate, the media instead moving through the openings in the plate.

2. The vibratory apparatus according to claim 1, wherein the vibration generator produces a vibratory force to cause an object and media within the container to be moved in a generally rising and falling path of rolling movement along the curved inner surface while being transported in the direction of the generally horizontally extending longitudinal axis from the input end toward the output end of the container.

3. The vibratory apparatus according to claim 1, wherein the first edge is disposed generally along the axis of the container.

4. The vibratory apparatus according to claim 3, wherein the second edge abuts the curved surface of the container.

5. The vibratory apparatus according to claim 3, wherein the second edge is disposed so that a gap exists between the second edge and the curved surface of the container.

6. The vibratory apparatus according to claim 1, wherein the plate is disposed at an angle relative to the horizontal.

7. The vibratory apparatus according to claim 1, wherein the openings are circular.

8. The vibratory apparatus according to claim 1, wherein the openings are non-circular.

9. The vibratory apparatus according to claim 1, wherein the dimensions of the openings vary.

10. The vibratory apparatus according to claim 9, wherein the dimensions of the openings vary between the first and second edges of the plate.

11. The vibratory apparatus according to claim 9, wherein the plate has a first end disposed at or near the input end and a second end disposed at or near the output end, and the dimensions of the openings vary between the first and second ends of the plate.

12. The vibratory apparatus according to claim 1, wherein the density per unit area of the openings vary.

13. A method of removing particular materials from an object, comprising:
disposing an object and media in a container having a curved inner surface disposed about a generally horizontally extending longitudinal axis, the container being resiliently supported above a base, and the container having a plate with a first edge spaced from the curved surface of the container and a second edge proximate to the curved surface of the container, the plate having openings therethrough;
applying a vibratory force to cause the object and media within the container to be moved in a generally rising and falling path of rolling movement along the curved inner surface,
the motion of the object being impeded by the plate while the motion of the media is not impeded by the plate, the media instead moving through the openings in the plate.

14. The method according to claim 13, the container having an input end and an output end, and the method comprising applying a vibratory force to cause the object and media within the container to be moved in a generally rising and falling path of rolling movement along the curved inner surface while being transported in the direction of the generally horizontally extending longitudinal axis from the input end to the output end.

15. The method according to claim 13, wherein the media passes further up the curved surface than the object before returning through the openings in the plate.

16. The method according to claim 13, wherein the first edge is disposed generally along the axis of the container.

17. The method according to claim 16, wherein the second edge abuts the curved surface of the container.

18. The method according to claim 16, wherein the second edge is disposed so that a gap exists between the edge and the curved surface.

19. The method according to claim 13, wherein the plate is disposed at an angle relative to the horizontal.
